(19) United States
(12) Patent Application Publication
(10) Pub. No.: US 2008/0084549 A1
(43) Pub. Date: Apr. 10, 2008

(54) HIGH REFRACTIVE INDEX MEDIA FOR IMMERSION LITHOGRAPHY AND METHOD OF IMMERSION LITHOGRAPHY USING SAME

(76) Inventors: Robert Earl Rottmayer, Wexford, PA (US); Michael Allen Seigler, Pittsburgh, PA (US)

Correspondence Address: BLYNN L. SHIDELER;THE BLK LAW GROUP, 3500 BROKKTREE ROAD, SUITE 200, WEXFORD, PA, 15090, US

(21) Appl. No.: 11/869,059

(22) Filed: Oct. 9, 2007

Related U.S. Application Data
(60) Provisional application No. 60/828,673, filed on Oct. 9, 2006.

(51) Int. Cl. G03B 27/42; G03C 1/00

(52) U.S. Cl. 355/53; 430/270.1

(57) ABSTRACT

In accordance with the present invention, a colloidal immersion lithography medium is provided. The medium comprises: a) a continuous liquid phase comprising a liquid having an index of refraction of at least 1.0, generally 1.4; and b) a plurality of particles having an average particle size between 1 nanometer and 2 microns and having an index of refraction of at least that of the liquid, substantially homogeneously dispersed in the liquid phase. Also provided are methods of preparing a colloidal immersion lithography medium, immersion lithography systems, and immersion lithography processes.

### RELATED APPLICATIONS

This application claims the benefit of U.S. Provisional Patent Application Ser. No. 60/828,673, filed Oct. 9, 2006 and entitled “HIGH REFRACTIVE INDEX MEDIA FOR IMMERSION LITHOGRAPHY

### BACKGROUND OF THE INVENTION

1. Field of the Invention

We, Robert E. Rottmayer and Michael A. Seigler have developed the present invention which relates to high refractive index colloids and their use as immersion liquids in immersion lithography systems and processes.

2. Background Information

In the semi-conductor industry, in particular, the microelectronic chip industry, there is a continuing drive toward higher device densities. Achieving higher densities requires formation of very small critical dimensions (CDs) such as width and spacing of interconnecting electrical lines on a semiconductor substrate.

High resolution lithographic processes are used to achieve these small CDs. Such lithographic techniques include immersion lithography, in which a substrate to be patterned, such as a wafer, and at least one surface of a focusing optical element such as a lens, are immersed in a liquid medium through which the exposing radiation is transmitted. Immersion lithography is a resolution enhancement technique that interposes the liquid medium between the optics and the wafer surface, replacing the usual air gap. This liquid medium has a refractive index greater than one. The wavelength in the liquid is inversely proportional to the refractive index of the liquid. A shorter wavelength improves the optical resolution. The medium has a higher refractive index than air. The use of immersion media with a high refractive index can increase numerical aperture, which is a lens's ability to collect diffracted light and focus fine details onto a substrate.

The medium between the lens and the substrate additionally needs to have a low optical absorption at the incident radiation wavelength, it must be chemically compatible with photoresist, the substrate, and the lens material, and it must be non-contaminating. Some liquids that are known to have high refractive indices contain toxins such as arsenic, requiring specialized disposal procedures. Others contain corrosives such as phosphoric acid that may be damaging to the substrate surface.

Thus, there is a need in the art to develop higher index immersion media that are environmentally safe and are compatible with the components of a lithographic system.

### SUMMARY OF THE INVENTION

In accordance with the present invention, a colloidal immersion lithography medium is provided. The medium comprises a) a continuous liquid phase comprising a liquid having an index of refraction of at least 1.0; and b) a plurality of particles having an average particle size between 1 nanometer and 2 microns and having an index of refraction of at least the index of refraction of the liquid, substantially homogeneously dispersed in the liquid phase. It should be understood that within the meaning of this application the index of refraction of the liquid is the index that the liquid exhibits prior to the addition of the particles. After the inclusion of the particles the index of refraction that is exhibited will be the index of the medium.

In accordance with one non-limiting embodiment of the present invention the liquid has an index of refraction of at least water and the particles have an index of refraction greater than that of water. The index of refraction for water is about 1.424 for wavelength of light of 200 nanometers. For the purposes of this application the index of refraction of a substance is calculated at 200 nanometers.

In accordance with one non-limiting embodiment of the present invention the liquid has an index of refraction of at least about 1.4 and the particles have an index of refraction greater than or equal to about 1.6.

In accordance with one non-limiting embodiment of the present invention the liquid has an index of refraction of at least about 1.42 and the particles have an index of refraction greater than about 2.0.

In accordance with one non-limiting embodiment of the present invention the particles have an average particle size between 1 nanometer and 200 nanometers. In accordance with another non-limiting embodiment of the present invention the particles have an average particle size between 1 nanometer and 25 nanometers. In accordance with a further non-limiting embodiment of the present invention the particles have an average particle size between 1 nanometer and 20 nanometers.

In accordance with the present invention, a method of preparing a colloidal immersion lithography medium comprising: a) providing a liquid having an index of refraction of at least 1.0 serving as a continuous liquid phase; and b) substantially homogeneously dispersing within the liquid a plurality of particles having an average particle size between 1 nanometers and 2 micrometers and having an index of refraction of at least the index of refraction of the liquid, thereby forming a colloid.

In accordance with the present invention, an immersion lithography system comprises a) a radiation light source; b) a lens element positioned to focus exposure radiation from the light source onto a target substrate; c) a photo-mask having a desired pattern; d) a target substrate having a photosensitive layer on the surface thereof facing the lens element; and e) a colloidal immersion medium; wherein the target substrate and at least one surface of the lens element are immersed in the medium, and wherein the medium comprises i) a continuous liquid phase comprising a liquid having an index of refraction of at least 1.0; and ii) a plurality of particles having an average particle size between 1 nanometers and 2 micrometers and having an index of refraction of at least the index of refraction of the liquid, substantially homogeneously dispersed in said liquid phase.

In accordance with the present invention, an immersion lithography process comprises the steps of: a) providing a radiation light source; b) providing a photo-mask having a desired pattern in the optics (between the condenser and the objective); c) positioning a lens element such that at least one surface of the lens element is immersed in a colloidal immersion medium, to focus exposure radiation from the light source onto a target substrate through the immersion medium; d) positioning the target substrate within the immersion medium wherein the target substrate has a photosensitive layer on the surface thereof facing the lens element; e) exposing the target substrate to radiation; and f) removing residual particles from the colloidal immersion medium from the surface of the substrate.

### DETAILED DESCRIPTION OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are each understood to be non-limiting with respect to the scope of the invention.

According to one non-limiting aspect of the present invention, a colloidal immersion lithography medium is provided, comprising: a) a continuous liquid phase comprising a liquid having an index of refraction of at least 1.0; and b) a plurality of particles having an average particle size between 1 nanometer (nm) and 2 microns and having an index of refraction of at least the index of refraction of the liquid, substantially homogeneously dispersed in said liquid phase.

The liquid may have an index of refraction of at least 1.4, often water at 1.424. Possibly the liquid may have an index of refraction greater than 2.0 within the scope of the present invention.

The liquid used in the continuous liquid phase may be organic or inorganic. For example, the liquid may be aqueous, such as ultrapure water. By “ultrapure” is meant that the water contains minimal contaminants that can deposit on the wafer, including dispersed or dissolved solids, liquids, or gases. Such contaminants may adversely affect the index of refraction (aka “refractive index”) or optical absorption of the water. Ultrapure water has been proposed as an acceptable immersion lithography fluid. Examples of suitable organic liquids include any conventional immersion oils as discussed and known in the art.

The particles may be charged particles or magnetic particles such that an electric or magnetic field can be used to force them into the liquid and can, with an opposite field, be used to draw them out of the liquid after lithography to remove any particles from the surface of the substrate.

The particles dispersed in the liquid phase typically have an average particle size of 1 nm to 2 microns, or often 1 nm to 200 nm, or 1 to 25 nm, or 18 to 20 nm. The particle size, particularly for nano-sized metallic particles, may be selected to create desired optical properties in the medium. The particle size may be small compared to the wavelength of incident radiation (often 193 nm, when an excimer laser is used for lithographic exposure) to prevent excessive light scattering.

The primary intended effect is for the particles to increase the effective refractive index of the medium without detrimentally affecting the optical absorption or other optical properties of the medium. Consequently, the index of refraction of the particles is greater than the index of refraction of the liquid. The refractive index of the particles is at least 1.0, often at least 1.4, and more often at least 1.6 and maybe over 2.0. Effective medium theories can be used to estimate the effective refractive index of the medium, i.e. the particles in the liquid. The Maxwell Garnet theory is one method of calculating effective refractive index for small filling fractions, f (i.e., less than 50 percent by volume) with essentially non-interacting particles:

$${n}_{{eff}^{2}} = {n}_{{m}^{2}} \frac{{}_{{np}^{2}} ( 2 - f ) + 2 {n}_{{m}^{2}} ( f - 1 )}{{n}_{{p}^{2}} ( f - 1 ) + {n}_{{m}^{2}} ( 1 + 2 f )}$$

where n_{eff} is the effective refractive index of the medium, nₘ is the refractive index of the liquid phase, and nₚ is the refractive index of the particles. See Aspens, D. E., and J. B. Theeten, 1979, “Investigation of effective-medium models of microscopic surface roughness by spectroscopic ellipsometry” Phys. Rev. B 20:3292-3302. More complex but well known theories are required for estimating the effective refractive index of media with higher concentrations of particles.

The particles are present in the medium in an amount of at least 0.1 percent by volume, generally at least 1.0 percent by volume, often at least 3.0 percent by volume, typically at least 10 percent by volume, and possibly at least 50 percent by volume based on the total volume of the medium. As described above, if the refractive index of the particles is higher than that of the liquid phase, as the concentration of particles in the medium increases, the effective refractive index of the medium also increases.

The particles used in the colloidal immersion lithography medium of the present invention may comprise organic or inorganic materials. The particles may alternatively comprise inorganic dielectrics such as diamond, diamond-like-carbon (DLC), Ta2O5, TiO2, SiN, HfO2, ZrO2, aluminum nitride, and/or Al2O3. Organic particles that may be used include polymeric materials such as polyetherimides.

In certain embodiments of the present invention, the particles may be soluble in the liquid phase, and the medium prepared such that the liquid phase is super-saturated with the particle material, and then additional particles are uniformly dispersed in the solution. For example, a liquid phase of water may be super-saturated with particles of aluminum nitride. This would allow for easy removal of residual particles from an exposed substrate with water rinsing.

The colloidal immersion lithography media described above may be prepared by first providing the liquid having an index of refraction of at least 1.0 serving as a continuous liquid phase; and substantially homogeneously dispersing within the liquid a plurality of particles as described above, having an average particle size between 1 nanometer and 2 microns and having an index of refraction of at least that of the liquid, thereby forming a colloid. As discussed above, preferably, the particles have an index of refraction greater than that of the liquid, whereby the index of refraction of the medium is higher than that of the liquid.

The particles may be introduced to the liquid under agitation and dispersed using any method known in the art of colloid formation. In order to avoid agglomeration of the particles in the medium, the particles may be coated or treated. The particles may be coated with material (both polar and apolar) to minimize the sticking of the particles on the resist layer. A similar coating may additionally or alternatively be placed on the resist to avoid particles remaining of the resist. This could ensure the particles remain with the liquid and in the medium.

The particles may be added in an amount at least sufficient to yield an effective index of refraction of the medium of at least greater than that of the liquid, generally greater than 1.424, and preferably in amounts yielding at least a 10 percent increase in the index of refraction of the liquid. Typically the particles are added in amounts as noted above. It can be seen that even small amounts of particles can have a measurable effect on the index of refraction of the medium

In certain embodiments of the invention wherein the particles are soluble in the liquid phase, they are first dissolved in the liquid until a super-saturated solution is formed, and then additional particles are dispersed in the super-saturated solution.

The colloidal immersion lithography media described above may be used in immersion lithography systems in accordance with the present invention. Such systems comprise:

a) a radiation light source;

b) a photo-mask having a desired pattern positioned between the lens element and the light source;

c) a lens element positioned to focus exposure radiation from the light source onto a target substrate;

d) a target substrate having a photosensitive layer on the surface thereof facing the lens element; and

e) a colloidal immersion medium comprising the medium described above. The target substrate, and at least one surface of the lens element are immersed in the medium during exposure.

The radiation light source may be any of those known in the art of lithography, including, for example, mercury light sources, visible light sources, ultraviolet light sources, and lasers. Typically the light source emits light at a wavelength between 100 and 500 nm, often 100 to 193 nm, or 193 to 248 nm. It has been observed that by lowering the wavelength of exposure radiation, CDs on semiconductor wafers can be reduced as well.

The lens element used in the lithography system of the present invention may be any of those useful in immersion lithography. At least one surface of the lens element is immersed in the colloidal medium. The lens may have a coating thereon to reduce the sticking of particles to the lens, with the coating being transparent with a high refractive index. The photo-mask positioned between the lens element and the light source may have any desired pattern, typically a circuitry pattern or the negative thereof, and may be of the type conventionally used in immersion lithography.

In certain embodiments, the target substrate comprises a semiconductor (e.g., silicon) wafer or chip. The photosensitive layer on the substrate may be positive- or negative-acting, depending on the nature of the photo-mask. The resist, also called the photosensitive layer, may be of the type conventionally used in immersion lithography, and may further include a non-stick coating as discussed above. An alternative dual layer resist is one in which the top layer is designed to dissolve away with a post exposure rinsing liquid that does not dissolve the bottom layer of the resist such that when dissolved it will take away the particles that may have been stuck to it. In these dual layer resist embodiments, the top layer need not be photosensitive, but rather could be transparent with a high refractive index.

A method of immersion lithography is also provided in accordance with the present invention, comprising the steps of:

a) providing a radiation light source;

b) positioning a lens element such that at least one surface of the lens element is immersed in a colloidal immersion medium, to focus exposure radiation from the light source onto a target substrate through the immersion medium;

c) positioning a photo-mask having a desired pattern between the lens element and the light source;

d) positioning a target substrate within the immersion medium wherein the target substrate has a photosensitive layer on the surface thereof facing the lens element, wherein the positioning includes properly aligning the substrate to the mask image, possibly in air and transferring that alignment of the exposure stage or other alignment device;

e) exposing the target substrate to radiation; and

f) removing any residual particles from the colloidal immersion medium from the surface of the substrate.

The colloidal immersion medium used in the lithography method of the present invention may, for example, be any of those described above; i.e., comprising:

a) a continuous liquid phase comprising a liquid having an index of refraction of at least 1.0; and

b) a plurality of particles having an average particle size between 1 nanometer and 2 microns and having an index of refraction of at least greater than the index of refraction of the liquid, substantially homogeneously dispersed in the liquid phase.

As noted above in step (f), it may be necessary after exposure to remove residual particles (left behind from the immersion medium) from the surface of the substrate, if they are not soluble in the developer. Various methods may be used to remove the particles, depending on the nature of the particles. Residual particles may be removed by rinsing with additional liquid used to prepare the continuous liquid phase, in which they may or may not be soluble. The residual particles may alternatively be removed using a liquid different from the continuous liquid phase in which the particles are soluble. The rinse liquid should be selected such that it is compatible with (i.e., does not damage) the substrate. In another embodiment, the particles may be etched away using a plasma etch, ion etch, react treated, such as oxygen ash, CHF etch or the like, that is typically used in wafer processing and does not damage the substrate. A quick dry or wet etch could be run after the substrate (e.g. wafer) is exposed. This quick dry or wet etch could remove any particles remaining on the resist but not remove significant amount of resist. For example, if the particles are TaO, SiO, or TiO (or combinations thereof), an F etch may be used to etch away the particles while removing little resist. As the particles are preferably small the etch may be short. The steps of the lithography method of the present invention otherwise follow those of a typical immersion lithography process.

Whereas particular embodiments of this invention have been described above for purposes of illustration, it will be evident to those skilled in the art that numerous variations of the details of the present invention may be made without departing from the invention as defined in the appended claims. The scope of the invention is defined by the appended claims and equivalents thereto.

What is claimed is:

1. A colloidal immersion lithography medium comprising:
a) a continuous liquid phase comprising a liquid having an index of refraction of at least 1.0; and
b) a plurality of particles having an average particle size between 1 nanometer and 2 microns and having an index of refraction of at least that of the liquid, substantially homogeneously dispersed in said liquid phase.

2.-13. (canceled)

14. A method of preparing a colloidal immersion lithography medium comprising:
a) providing a liquid having an index of refraction of at least 1.0 serving as a continuous liquid phase; and
b) substantially homogeneously dispersing within the liquid a plurality of particles having an average particle size between 1 nanometers and 2 microns and having an index of refraction of at least that of the liquid, thereby forming a colloid.

15.-27. (canceled)

28. An immersion lithography system comprising:
a) a radiation light source;
b) a lens element positioned to focus exposure radiation from the light source onto a target substrate;
c) a photo-mask having a desired pattern positioned between the lens element and the light source;
d) a target substrate having a photosensitive layer on the surface thereof facing the lens element; and
e) a colloidal immersion medium; wherein the target substrate and at least one surface of the lens element are immersed in the medium, and wherein the medium comprises:
i) a continuous liquid phase comprising a liquid having an index of refraction of at least 1.0; and
ii) a plurality of particles having an average particle size between 1 nanometers and 2 microns and having an index of refraction of at least that of the liquid, substantially homogeneously dispersed in said liquid phase.

29.-43. (canceled)

44. A method of immersion lithography, comprising the steps of:
a) providing a radiation light source;
b) positioning a lens element such that at least one surface of the lens element is immersed in a colloidal immersion medium, to focus exposure radiation from the light source onto a target substrate through the immersion medium;
c) positioning a photo-mask having a desired pattern between the lens element and the light source;
d) positioning the target substrate within the immersion medium wherein the target substrate has a photosensitive layer on the surface thereof facing the lens element;
e) exposing the target substrate to radiation; and
f) removing any residual particles from the colloidal immersion medium from the surface of the substrate.

45. The method of claim 44 wherein the colloidal immersion medium comprises:
i) a continuous liquid phase comprising a liquid having an index of refraction of at least 1.0; and
ii) a plurality of particles having an average particle size between 1 nanometers and 2 microns and having an index of refraction of at least that of the liquid, substantially homogeneously dispersed in said liquid phase.

46. The method of claim 44 wherein the radiation light source emits light having a wavelength of from 100 to 500 nm and wherein the photosensitive layer is positive-acting.

47. (canceled)

48. The method of claim 44 wherein the target substrate comprises a semi-conductor wafer.

49. The method of claim 44, wherein in step (f), residual particles are removed by rinsing with additional liquid used to prepare the continuous liquid phase of (i).

50. The method of claim 44, wherein in step (f), residual particles are removed using a liquid in which the particles are soluble.

51. The method of claim 45 wherein said continuous liquid phase comprises a liquid having an index of refraction of at least 1.4.

52. The method of claim 51 wherein said liquid is ultrapure water.

53. The method of claim 45 wherein said liquid comprises an immersion oil.

54. The method of claim 45 wherein said particles are inorganic.

55. The method of claim 54 wherein said particles comprise a dielectric material.

56. The method of claim 55 wherein said particles comprise diamond, DLC, Ta2O5, TiO2, SiN, HfO2, ZrO2, aluminum nitride, and/or Al2O3.

57. (canceled)

58. The method of claim 54 wherein said particles comprise aluminum, Au, Ta, Hf, Pt, Ti, or Ag.

59. The method of claim 45 wherein said particles are organic.

60. The method of claim 59 wherein said particles comprise polyetherimide.

61. The method of claim 45 wherein said particles are present in the colloidal immersion medium in an amount of at least 3 percent by volume, based on the total volume of the medium.

62. The method of claim 45 wherein the particles are soluble in the liquid phase and are dispersed in a super-saturated solution of the particles in the liquid.
